(19) United States
(12) Patent Application Publication
(10) Pub. No.: US 2011/0215207 A1
(43) Pub. Date: Sep. 8, 2011

(54) DRIVING COLUMN WITH MEMORY AND PIECE OF FURNITURE WITH SUCH A DRIVING COLUMN

(76) Inventors: Michael Köder, Plochingen (DE); Michael Buitmann, Kirchheim unter Teck (DE)

(21) Appl. No.: 12/847,488

(22) Filed: Jul. 30, 2010

(30) Foreign Application Priority Data
Mar. 8, 2010 (EP) 10155788.2

(51) Int. Cl. F16M 11/24; F16M 11/26; A47B 9/20; B23P 11/00; H01R 43/00

(52) U.S. Cl. 248/157; 248/188.2; 29/428; 29/825

(57) ABSTRACT

A driving column (6), for instance of a piece of furniture (9), comprises a motor (1), a motor board (2), a motor supply cable (3) and a motor plug (4). In the driving column (6) an identification means (5) is integrated either into the motor board (2), the motor supply cable (3), or the motor plug (4), having data for identification of the respective driving column (6) stored therein. During the assembly, these data are assigned to the control unit (10) of the piece of furniture (9) to program it accordingly, such that a danger of confusion is reduced and the manufacturing process is simplified.

The present invention concerns a driving column with a memory and in particular such a driving column for a piece of furniture.

In modern office equipments it often is desired that in particular the tables are flexible in their use. For instance, it serves for a better body posture, if the height of a surface of a table can be adjusted to the body size. The adjustment of a table for use while standing or with a tilted table plate is also often desired, to enable for an ideal working position or a change between different working positions.

An adjustment of the height for instance of a table plate, however, can be very complicated, depending on the weight of the plate or their attachment. For this reason, electro-mechanical adjustment means are used, for example to electro-mechanically control columns supporting the table plates. Such controls thereby also allow further functions, such as child-proof locks, stored and preferred positions, height displays and such.

A height-adjustable drive for use in a piece of furniture for instance is known from DE 20 2005 021 004 U1. Such drives comprise a motor and mechanical driving components. These are arranged in a driving column.

After final assembly, the columns are subjected to a 100% inspection proceeding in an automated manner. This inspection serves the review of the functionality of the individual components.

In addition, a control unit and a manual control switch are provided to move and to synchronize these units. The control units used are separately provided with the respective control program and have to be allocated to the respective column after the assembly.

Since this is a separate procedure, a certain effort is required during the production, and it may lead to confusions during the junction of drives and controls.

It is therefore the object of the invention, to provide a driving column or a piece of furniture with a driving column, enabling for simplified production and an uncomplicated assembly, without yielding a danger of confusion during the assembly.

This object is achieved according to the invention by the devices according to any of the patent claims 1, 6 or 12, as well as by the method according to patent claim 13. Advantageous developments are subject to the dependent claims.

The advantages achieved with the invention are in particular that a driving column comprises an electronical identification means. The identification means has identification data stored, which can be sent to a control unit of a piece of furniture. Thereby, the respective driving column can be identified clearly, and there is no danger of confusing the individual drives.

Furthermore, it is an advantage that no separate control units, or control units geared to individual demands, have to be pre-programmed. Thus, always the same unprogrammed control units can be used for the different applications, and major simplifications arise during the manufacturing and assembly process are achieved. This further reduces the administrative effort.

Therein, the identification means can be a simple memory or also a micro controller, which can directly take over the control of the drive. This enables for a de-central control, independent of the respective control device. Therefore, in combination with a means for detecting the present displacement, a self-regulation of the displacement is enabled.

The memory can comprise a control unit, which allows a control of the driving column.

In addition, the driving column advantageously is combined with a piece of furniture, wherein the piece of furniture comprises a control unit for detecting and for controlling the individual driving columns, as well as a data connection means serving for data exchange.

A further advantageous development of the invention is that the identification means is provided with a data connection means. By this, a data connection, which advantageously can also be a wireless connection, is possible between the piece of furniture and the individual driving columns, but also directly between the driving columns.

Details, advantages and further developments of the invention will be described in more detail with one embodiment, referring to the illustration. Therein shows:

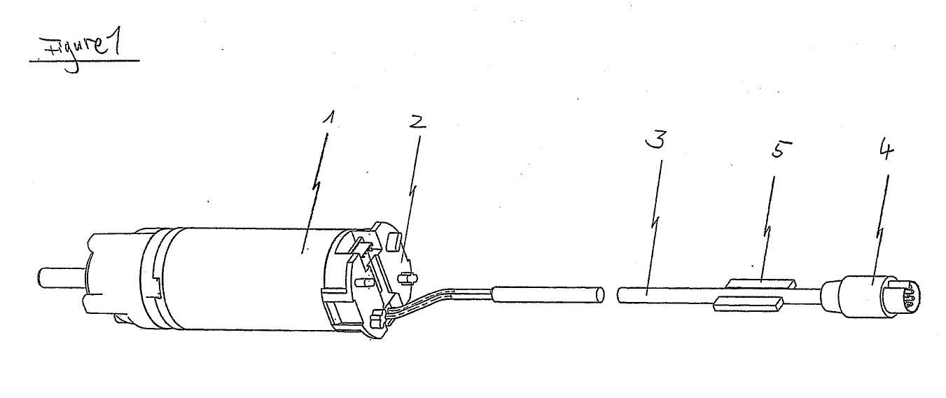

FIG. 1 a side view of a driving source of a driving column;

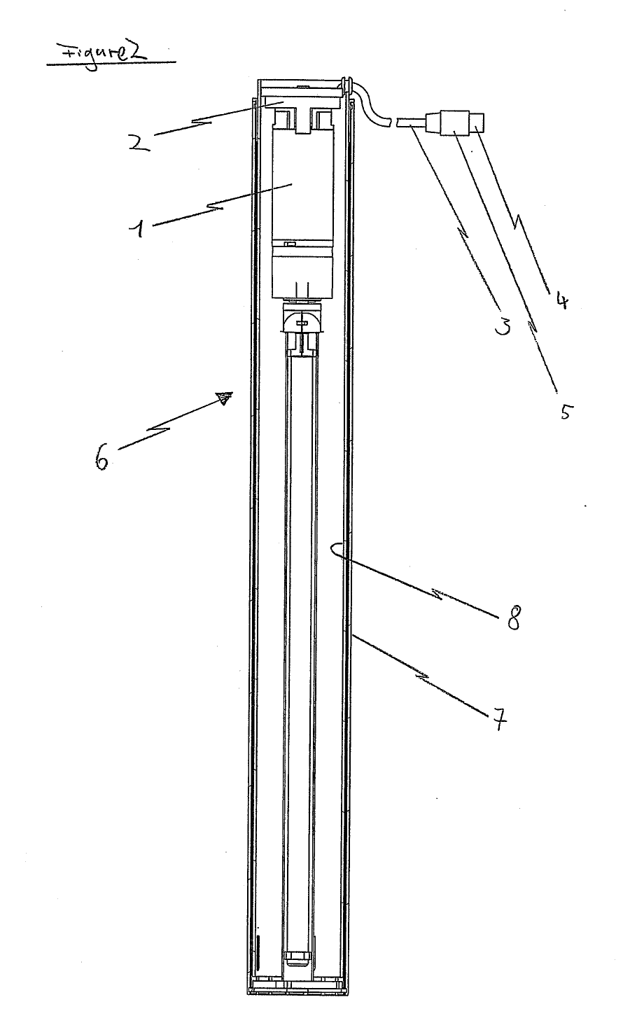

FIG. 2 a simplified illustration of a driving column; and

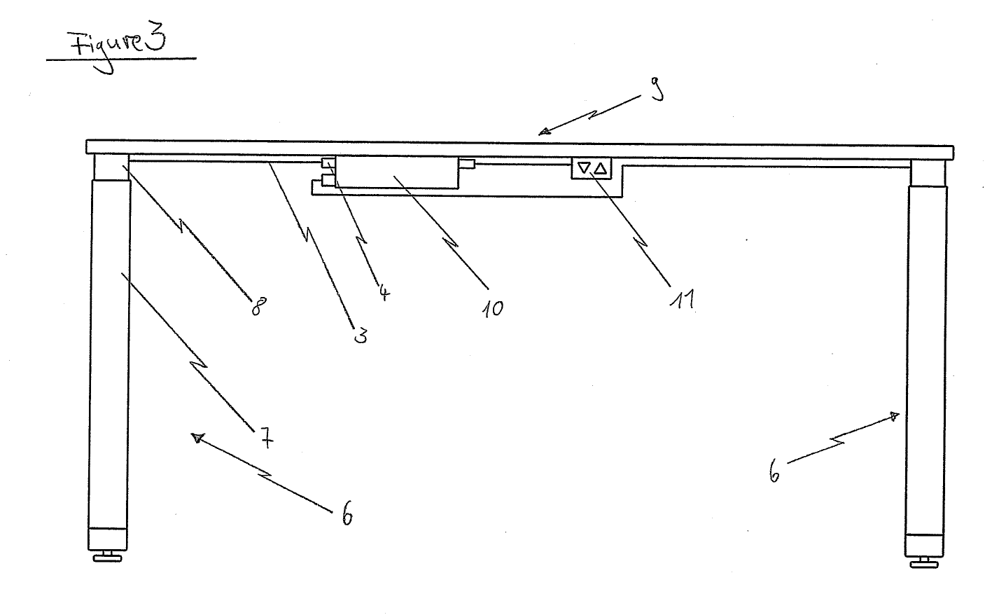

FIG. 3 a piece of furniture with mounted driving columns and a control unit.

The illustration in FIG. 1 shows a driving source of a driving column 6. The driving source comprises a motor 1. In the preferred embodiment, the peripheral surface of the motor 1 resembles a cylinder barrel, such that this essentially is a clogged surface.

In other embodiments, the motor can comprise a different shape, according to the respective purpose of use and position of use.

The driving column 6 further comprises a motor board 2. The motor board 2 is arranged at one first face of the motor 1. The motor board 2 comprises the same maximal outer circumference as the motor 1 such that no components of the motor board 2 protrude in a radial direction from the peripheral surface. The motor board 2 therein comprises a plurality of electrical connections.

Further, the driving source comprises a motor supply cable 3. In the preferred embodiment of the present invention, the motor board 2 is connected with the motor supply cable 3 at a plug connection. The motor supply cable 3 here is a multi-core cable.

The driving source further comprises a motor plug 4. In the preferred embodiment, the different cores of the motor supply cable 3 join in this motor plug 4.

In further developments, instead of a single cable a plurality of cables can be used. Consequently it is also possible, that instead of the one motor plug 4 a plurality of plugs can be used.

The driving column 6, into which the driving source is inserted, consists of a fixed portion 7 (for instance, a main pillar of a piece of furniture, as described later) and of a movable portion 8 (compare FIG. 2). The movable portion 8 can be moved relative to the fixed portion 7 by the driving source.

Therein, the fixed portion 7 and the movable portion 8 are built for instance such that they can be moved in a telescopic way with respect to each other.

A transmission of the motor 1 is joined to the motor 1 at a second face averted from the motor board 2 of the motor 1.

In the preferred embodiment, the motor is an electrical step motor, causing the movement of the movable portion 8 with respect to the fixed portion 7 by a mechanical contact.

However, in other embodiments, it is possible that the motor is for instance a compressor motor such that a movement of the portions with respect to each other is caused by compressed-air.

According to the invention, an identification means is provided in the driving source, which can be read out electronically, and which in the following is denoted as electronic identification means 5. The identification means 5 can for example either be integrated into the motor board 2, the motor supply cable 3 (compare embodiment according to FIG. 1) or the motor plug 4 (compare embodiment according to FIG. 2). It only has to be ensured that a power supply for or a data connection with the identification means 5 is possible.

The identification means 5 in the preferred embodiment is built as a memory. On the memory, identification data are stored in electronical form. These identification data can contain information on the specific type of driving source, the driving data of the driving source and the like. However, there are at least such data provided on the identification means 5 that a control of the driving source is possible.

In the preferred embodiment, the identification means 5 comprises data connection means. The function of this data connection means will be explained later.

As is shown in FIG. 2, the above described driving source is provided in a driving column 6 in use according to the invention. The external shape of the motor and of the board correspond to the shape of the column, in which the driving source is provided.

The driving column 6 preferably is a part of a piece of furniture 9, for example a pillar of a table or of a chair, or similar (compare FIG. 3).

As shown in FIG. 3, the piece of furniture 9 itself comprises a control unit 10. The control unit 10 for instance is arranged below a table plate of the piece of furniture 9, or therein. In the present embodiment, the control unit 10 is connected with a manual control switch 11. The manual control switch 11 enables the user to operate the piece of furniture 9. The connection between the control unit 10 and the manual control switch 11 can be effected either via cable or wireless. In the latter case, possible ways of transmission for instance can be radio, infrared, Bluetooth and the like.

The control unit 10 further comprises a data connection means. With this data connection means it is possible to establish a data connection with other data connection means. In a preferred embodiment, the data connection means comprise both a transmitter and a receiver unit.

In other embodiments it is possible that the control unit of the piece of furniture only comprises either a transmitter unit or a receiver unit.

Additionally, in the preferred embodiment, a driving column 6 is integrated into the piece of furniture. However, it is also possible that more than one driving column 6 is provided (compare FIG. 3).

According to the invention, the driving source is integrated into the driving column 6 and mounted therein. The driving column 6 again is part of a piece of furniture 9, for instance as a pillar of a table, or as a part of a pillar. The driving column 6 is then mounted to the piece of furniture 9 in an adequate way.

One step during assembly comprises establishing of a mechanical connection between the driving column 6 and the piece of furniture 9. A further step during assembly is establishing a power supply for the motor 1. The power supply is achieved via the motor supply cable 3 by connecting the motor plug 4 with an indirect or direct power source. In the preferred embodiment, the control unit 10 of the furniture 9 serves as an indirect power source, which again is connected to a power supply. The multi-core motor supply cable 3 in this embodiment at the same time serves as connecting means between the data connecting means of the control unit 10 and the identification means 5 of the driving column 6. The data connecting means connects the control unit 10 with the identification means 5 of the driving column 6, as well as with the motor board 2. A control of the motor 1 thus can be accomplished by the control unit 10 of the piece of furniture 9.

In the preferred embodiment, the identification means 5 is formed as a memory. This memory can be an EEPROM, for example. However, it is also possible that the identification means 5 is a micro-controller or an entire control unit, as long as they are also able to save and transmit the relevant data. For reasons of an easier production, as in the case of the embodiment according to FIG. 2, the identification means 5 preferably is integrated into the motor plug 4.

In other embodiments, the power supply and the data connecting means can be formed as separate cables, such that in particular the power supply of the driving column does not have to be achieved by means of the control unit.

In a further step, after mechanical assembly of the driving column 6, the data connection is established between the identification means 5 and the control unit 10, in particular between their data connecting means. In the preferred embodiment, the identification means 5 of the driving column 6 here transmits data to the control unit 10. In particular, these data include the moving data of the driving column 6, or of the motor 1 of the driving column 6. Thus, an exact allocation of the driving column 6 is ensured, and the danger of confusion is reduced. Thereby, at the same time, a correct control of the motor 1 is ensured.

In this preferred embodiment, the control unit 10 does not have to be specifically pre-programmed for customer requests anymore. Rather, the control unit 10 is programmed by the identification means 5 due to the data transmission.

Then, the control unit 10 takes over control of start and stop of the motor 1, as well as its power supply or its power outlet.

In the present embodiment, the data connection is established with a cable being integrated in the multi-core motor supply cable 3. Thereby, the data connecting means of the identification means 5 and the data connecting means of the control unit 10 are directly connected with each other. Data traffic can take place in both directions, even if in the preferred embodiment, this only has to take place from the identification means 5 to the control unit 10 of the piece of furniture 9.

In a further embodiment, it is also possible that the identification means 5 and the control unit 10 of the piece of furniture 9 are connected wireless. In this case, both the identification means 5 and the control unit 10 of the piece of furniture 9, comprise a transmitter or receiver unit, or preferably both. The data transmission can be achieved by common transmission methods, such as radio, infrared, Bluetooth or the like.

In a further embodiment it is also possible that more than one driving column is allocated to one control unit 10. In this case, the control unit 10 establishes a connection with all identification means in the driving columns. Furthermore, the control unit 10 controls start and stop as well as the power of the individual motors, and synchronizes the individual driving columns. Further, it is also possible that the individual identification means establish a data connection with one another.

If a micro-controller or a control unit is used as the identification means 5 in the driving column 6, a de-centralized control of the driving columns can be achieved. Such a de-centralized control can then be achieved in the piece of furniture 9, independent of the control unit 10. The synchronization of the driving columns can then also be achieved independent of the control unit 10 of the piece of furniture 9.

Furthermore, in the preferred embodiment, means for detecting the adjustment of the driving column are provided (not shown). In this case, these means detect the lifting position of the driving column 6. For example, so-called “Hall-ICs” can be used. These detect the rotational position of the motors and thus enable a conclusion with regard to the respective lifting position.

In a further embodiment, it is additionally possible that the driving column 6 or the piece of furniture 9 comprise further means for detecting the adjustment of the driving column 6. It is thus possible that a means detects the absolute height of a table plate above the ground, or having a slope of a table plate measured in various planes. These measurement signals then enable for re-adjustment either being performed by the control unit 10 of the piece of furniture 9 or by the identification means 5 of the driving columns 6.

In summary, it can be said that in a preferred embodiment a driving column 6, for example of a piece of furniture 9, comprises a motor 1, a motor board 2, a motor supply cable 3 and a motor plug 4. In the driving column 6, an identification means 5 is integrated into either the motor board 2, the motor supply cable 3, or the motor plug 4, having data deposited for identification of the respective driving column 6. During assembly, these data are assigned to a control unit 10 of the piece of furniture 9 and program the latter accordingly, such that a danger of confusion is reduced and the production process is simplified.

1-14. (canceled)

15. A driving column comprising a fixed portion, a movable portion and a driving source for moving the movable portion relative to the fixed portion, and wherein further the driving column comprises an electronic identification means.

16. The driving column according to claim 1, wherein the identification means is a memory with electronic data stored therein allowing an identification of the driving column.

17. The driving column according to claim 2, wherein the memory is part of a control unit.

18. The driving column according to claim 2, wherein the memory is part of a micro-controller.

19. The driving column according to claim 1, wherein further the driving column comprises means for determining the current displacement of the movable portion.

20. The driving column according to claim 2, wherein the driving source comprises a motor including a motor board, a motor supply cable, and a motor plug, and wherein further the memory is provided in one of the motor board, motor supply cable or motor plug.

21. The driving column according to claim 1, wherein the identification means further comprise data connection means.

22. A piece of furniture, comprising:
at least one driving column comprising a fixed portion, a movable portion and a driving source for moving the movable portion relative to the fixed portion, and wherein further the driving column comprises an electronic identification means;
a control unit for controlling the at least one driving column, the control unit including data connection means being connected with the electronic identification means of the at least one driving column.

23. The piece of furniture according to claim 8, wherein the identification means of the at least one driving column comprises data connection means.

24. The piece of furniture according to claim 9, wherein the data connection means of each of the identification means and the control unit includes a transmitter and/or a receiver unit.

25. The piece of furniture according to claim 10, wherein the data connection means of each of the identification means and the control unit are wirelessly connected.

26. The piece of furniture according to claim 8, comprising a plurality of driving columns, each driving column being controllable independently of the other driving columns.

27. The piece of furniture according to claim 9, comprising a plurality of driving columns, each driving column being controllable independently of the other driving columns.

28. The piece of furniture according to claim 10, comprising a plurality of driving columns, each driving column being controllable independently of the other driving columns.

29. The piece of furniture according to claim 11, comprising a plurality of driving columns, each driving column being controllable independently of the other driving columns.

30. The piece of furniture according to claim 12, wherein the electronic identification means of each of the plurality of driving columns are in direct data connection with each other.

31. A method for assembling a piece of furniture, comprising the following steps:
(a) providing a piece of furniture comprising:
(i) at least one driving column comprising a fixed portion, a movable portion and a driving source for moving the movable portion relative to the fixed portion, and wherein further the driving column comprises an electronic identification means;
(ii) a control unit for controlling the at least one driving column, the control unit including data connection means being connected with the electronic identification means of the at least one driving column; and
(b) establishing a mechanical connection and a data connection between the piece of furniture and the at least one driving column, and wherein, after establishing the data connection between the control unit and the at least one driving column, the electronic identification means of the driving column transmits identification data to the control unit.

32. The method according to claim 17, wherein the step (a) comprises providing a piece of furniture comprising a plurality of driving columns, and wherein further in the step (b) a data connection is established between the individual driving columns to one another and with the control unit of the piece of furniture.
